(19) United States
(12) Patent Application Publication
(10) Pub. No.: US 2023/0015052 A1
(43) Pub. Date: Jan. 19, 2023

(54) Method for a Vehicle Part Exchange Program

(71) Applicant: Wheel Pros, LLC, Greenwood Village, CO (US)

(72) Inventors: Cody Mayer, Atlanta, GA (US); Brian Reese, Atlanta, GA (US)

(73) Assignee: Wheel Pros, LLC, Greenwood Village, CO (US)

(21) Appl. No.: 17/848,223

(22) Filed: Jun. 23, 2022

Related U.S. Application Data
(60) Provisional application No. 63/223,359, filed on Jul. 19, 2021.

(51) Int. Cl. G06Q 30/06; G06Q 30/02

(52) U.S. Cl. CPC G06Q 30/0611; G06Q 30/0206; G06Q 30/0635

(57) ABSTRACT

A method and related software program for the purchasing,selling and exchanging of motor vehicle parts provides an efficient means to save customers money off the purchase of new parts and to effectively recycle old vehicle parts. In differing embodiments, the program may be software or a mobile application that allows a user to obtain the value of unneeded automobile parts. Further, the user can input a plurality of criteria related to the part in order to obtain the value, wherein third parties can also offer to buy the part.

### CROSS REFERENCE TO RELATED APPLICATIONS

This Utility Patent Application claims priority back to U.S. Provisional Application No. 63223359, filed Jul. 19, 2021, the contents of which are incorporated in their entirety by reference.

### STATEMENT REGARDING FEDERALLY SPONSORED RESEARCH OR DEVELOPMENT

This invention was not federally sponsored.

### FIELD OF THE INVENTION

The present invention relates generally to the field of purchasing, selling and exchanging motor vehicle parts. More specifically, the present invention relates to a method and related software program for the purchasing, selling and exchanging of motor vehicle parts. In differing embodiments, the program may be software or a mobile application that allows a user toobtain the value of unneeded vehicle parts. Further, the user can input a plurality of criteria relatedto the part in order to obtain its value, and wherein third parties can also offer to buy the part. Accordingly, the present disclosure makes specific reference thereto. Nonetheless, it is to be appreciated that aspects of the present invention are also equally applicable to other like applications, devices and methods of manufacture.

### BACKGROUND

Consumers within the automobile industry regularly buy performance aftermarket vehicle parts to replace the OEM parts of a vehicle. However, the replaced OEM parts are still valuable, yet many consumers are not aware of their value, and as a result do not attempt to resellthe parts. Further, a user may not desire to go through the effort of listing and selling the part on an online marketplace. As a result, usable and valuable parts are regularly discarded or stored awaydue to these reasons.

Therefore, there exists a long-felt need in the art for a program that informs a user on the value of an unneeded automobile part. Further, there exists a long-felt need in the art for a program that allows a user to easily sell an unneeded automobile part. Finally, there exists a long-felt need in the art for a program that allows interested parties to purchase unneeded parts from users.

The subject matter disclosed and claimed herein, in one embodiment thereof, comprisesa software program for used vehicle parts. The program may be in the form of software or a mobileapplication for smart devices, wherein the program calculates the value of an automobile part basedon a number of criteria related to vehicle/part information. The program then calculates the value

of the part based on the current market value and the year/make/model/trim of the vehicle from which the part originates. Then, the program will offer to buy (e.g., trade-in) the part via a purchase,exchange, rebate, or discount on behalf of another party that uses the program such as a collision repair shop or other vendor (e.g., wherein the vendor is any other party other than the first user who has the used part for trade-in), who may also resell or keep the part.

In this manner, the software program for used vehicle parts of the present invention accomplishes all of the forgoing objectives and provides an improved means for a user to obtain the value of an unneeded automobile part. Further, the program allows a user to easily sell/trade—in unneeded parts directly to vendors via the program. Finally, the program allows interested vendors/buyers to easily obtain unneeded vehicle parts.

### SUMMARY OF THE INVENTION

The following presents a simplified summary in order to provide a basic understanding of some aspects of the disclosed innovation. This summary is not an extensive overview, and it isnot intended to identify key/critical elements or to delineate the scope thereof. Its sole purpose is to present some general concepts in a simplified form as a prelude to the more detailed descriptionthat is presented later.

The subject matter disclosed and claimed herein, in one embodiment thereof, comprises a method and related software program for use in the valuing, purchasing, selling, and exchangingof motor vehicle parts. In differing embodiments, the program may be in the form of software ora mobile application for smart devices, wherein the program calculates the value of an automobile part based on a number of criteria related to vehicle/part information. The program then calculatesthe value of the part based on the current market value and the year/make/model/trim of the vehiclethe part originates from. Then, the program will offer to buy or trade-in the part via a purchase, exchange, rebate, or discount on behalf of another party such as a collision repair shop or other vendor using the program. Further, this vendor may choose to retain or resell the part to another party without or without the use of the program.

The program may also be comprised of a method for obtaining and selling automobileparts using the program. The first step of the method involves a first user of the program obtaininga singular best offer for a part from various vendors within the program. In forming the best offer,a plurality of criteria can be considered by the program including but not limited to: the shipping

cost of the part, seasonal variations in used part market pricing, current best market pricing, third-party (e.g., buyer) volume demands/valuations for parts, item condition (ex. new, like-new, gentlyused, used, etc.), vehicle year/make/model/trim that the part come from, etc. Then, the user can choose to accept the best offer. Once program has purchased the trade-in part (wherein the purchase was made on behalf of a vendor), the vendor may choose to resell the part or may retainthe part using/not using the program.

Further, the program may be comprised of a method of facilitating the sale of used automobile parts. First, a user trades-in vehicle parts using the program, wherein the program prompts the user to trade-in the part while the user attempts to purchase a new part. The user canselect vehicle information to get a quoted trade-in value price that the program will pay for their part. If selected by the user, the trade-in option is added to a shopping cart as an unpriced item, and after the user purchases the trade-in, additional details/instructions and a shipping label are sent to the user. Next, the user packages and ships the part, wherein it is received by a refurbisherwho inspects the part and confirms the part number and condition. Finally, once the part has beenapproved by the refurbisher and purchaser, the purchaser (e.g., a vendor using the program) can pay the user directly based on the agreed to price/terms.

Therefore, the improved software program for suer vehicle parts of the present invention is particularly advantageous as it allows users to sell parts that would otherwise go unsold. Further, the program allows users to obtain a fair market value for their part. In addition, the program allows interested buyers to easily acquire (and even resell) used parts.

To the accomplishment of the foregoing and related ends, certain illustrative aspects of the disclosed innovation are described herein in connection with the following description and theannexed drawings. These aspects are indicative, however, of but a few of the various ways in which the principles disclosed herein can be employed and are intended to include all such aspectsand their equivalents. Other advantages and novel features will become apparent from thefollowing detailed description when considered in conjunction with the drawings.

### BRIEF DESCRIPTION OF THE DRAWINGS

The description refers to provided drawings in which similar reference charactersrefer to similar parts throughout the different views, and in which:

FIG. 1 illustrates a block diagram of the essential components of one potential embodiment of a software program for used vehicle parts of the present invention in accordance with the disclosed architecture;

FIG. 2 illustrates a flow diagram of a method of obtaining and selling automobile partsusing one potential embodiment of a software program for used vehicle parts of the present invention in accordance with the disclosed architecture; and

FIG. 3 illustrates a flow diagram of a method of facilitating the sale of used automobileparts using one potential embodiment of a software program for used vehicle parts of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understandingthereof. It may be evident, however, that the innovation can be practiced without these specific details. In other instances, well-known structures and devices are shown in block diagram form in order to facilitate a description thereof. Various embodiments are discussed hereinafter. It shouldbe noted that the figures are described only to facilitate the description of the embodiments. Theyare not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a program that informs a useron the value of an unneeded automobile part. Further, there exists a long-felt need in the art for aprogram that allows a user to easily sell an unneeded automobile part. Finally, there exists a long-felt need in the art for a program that allows interested parties to purchase unneeded parts from users.

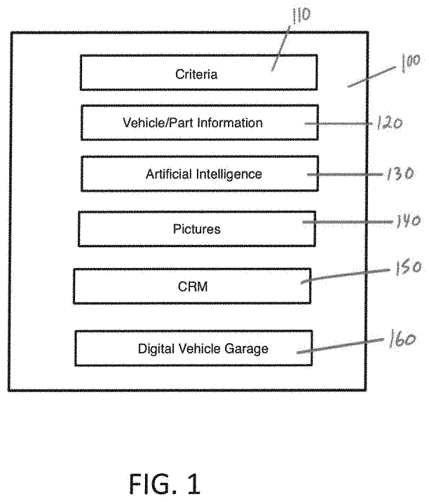

Referring initially to the drawings, FIG. 1 illustrates a block diagram of the essential components of one potential embodiment of a software program for used vehicle parts 100 of thepresent invention in accordance with the disclosed architecture. The program 100 may be in the form of software or a mobile application for smart devices, wherein the program 100 calculates

the value of an automobile part based on a number of criteria 110 such as: shipping cost of the part, seasonal variations in used part market pricing, current best market pricing, third-party (e.g., buyer) volume demands/valuations for parts, item condition (e.g., new, like-new, gently used, used,etc.), and vehicle year/make/model/trim that the part comes from. Further, the program 100 may be used with an existing online sales platform for automobile parts.

In order to further aid a user in identify all relevant information regarding a part, theprogram 100 may also allow a user to input vehicle/part information 120 such as: VIN number, RPO code, alpha-numerical markings, license plate number of the vehicle the part originates from,part number, bulb type, tire size, etc. Further, the program 100 may contain an artificial intelligence130 that allows a user to upload a picture to the program 100, which is then scanned by the AI 130 to determine the part number. Further, the program 100 may display various pictures 140 to theuser to allow the user to select the photo of the part that matches their part and/or vehicle. Finally,the program 100 may contain a cross-platform CRM 150 that allows a user to refer to their pastpurchase history across various automotive websites. In addition, the purchase history may containa digital “vehicle garage” 160 that displays all parts in an interactive digital photograph manner.

In one embodiment of the program 100, the program 100 can be used by automobile part companies (such as aftermarket head and taillight companies) who then can sell used partsthey obtain from the program to other interested parties (such as collision repair centers). It is also contemplated that the program can be used to purchase, sell or exchange any type of vehicle parts.Said parts include, but are not limited to: headlights, taillights, wheels, body trim, seats, stereos,etc. Further, one embodiment of the program 100 may be used to purchase, sell or exchange aftermarket parts, in addition to OEM/used parts.

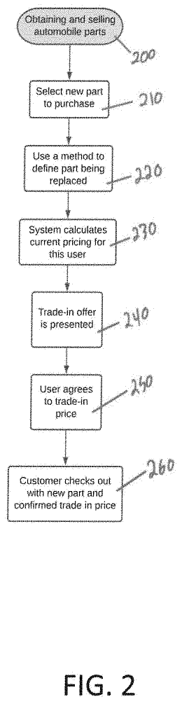

FIG. 2 illustrates a flow diagram of a method 200 of obtaining and selling automobile parts using one potential embodiment of a software program for user vehicle parts 100 of the present invention in accordance with the disclosed architecture. The program 100 may include a method 200 for obtaining and selling automobile parts using the program 100. First, a first user ofthe program can attempt to purchase a new part from the program (Block 210). Next, the program100 uses a method to define the part being replaced (Block 220). Then, the program 100 calculatesand offers a best offer from various vendors for the part trade-in part (Block 230) to which the best offer is presented (Block 240) and can be considered in real-time by the user. In determining the best offer, the program 100 evaluates a plurality of criteria such as, but not limited to, the shipping cost of the part, seasonal variations in used part market pricing, current best market pricing, third-party (e.g., buyer) volume demands/valuations for parts, item condition (e.g., new, like-new, gently used, used, etc.), and the vehicle year/make/model/trim that the part comes from. Then, the user can choose to accept an offer price from the program 100 (Block 250). Once accepted, the user can then checkout to purchase the new part and confirm the trade-in price of the used part (Block260). After the trade-in is complete, the vendor may also choose to purchase the part for themselvesor sell the part to an additional party such as a collision repair shop or other willing purchaser viathe program 100 or without the program 100.

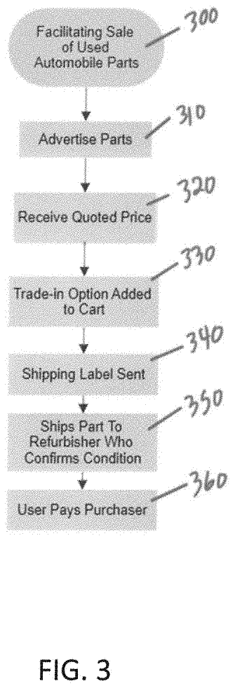

FIG. 3 illustrates a flow diagram of a method 300 of facilitating the sale of used automobile parts using one potential embodiment of a software program for used vehicle parts 100 of the present invention in accordance with the disclosed architecture. The program 100 can also include of method 300 of facilitating the sale of used automobile parts. First, a first user may be prompted to trade-in vehicle parts using the program (Block 310) while purchasing new parts from an existing online marketplace/software that the program 100 is integrated within. Then, a user can select relevant vehicle information to get a quoted trade-in value price that the program 100 will pay for their part (Block 320). If selected by the user, the trade-in option is added to a shopping cart as an unpriced item (Block 330). After the user purchases the trade-in, additional details/instructions and a shipping label are sent to the user (Block 340). Next, the user packages and ships the part, wherein it is received by a refurbisher who inspects the part and confirms the part number and condition (Block 350). Finally, once the part has been approved by the refurbisherand the purchaser, the purchaser can pay the user directly based on the agreed to price/terms (Block 360). As noted above, the purchaser (e.g., a vendor using the program 100) can then also sell the part to another party with or without the program 100 after the sale.

Certain terms are used throughout the following description and claims to refer to particular features or components. As one skilled in the art will appreciate, different persons mayrefer to the same feature or component by different names. This document does not intend to distinguish between components or features that differ in name but not structure or function. As used herein “software program for used vehicle parts” and “program”, are interchangeable and refer to the software program for used vehicle parts 100 of the present invention.

Notwithstanding the forgoing, the software program for used vehicle parts 100 of the present invention and its various components can be of any suitable size and configuration as is

known in the art without affecting the overall concept of the invention, provided that they accomplish the above-stated objectives. One of ordinary skill in the art will appreciate that the size, configuration and material of the software program for used vehicle parts 100 as shown in the FIGS. are for illustrative purposes only, and that many other sizes and shapes of the software program for used vehicle parts 100 are well within the scope of the present disclosure. Although the dimensions of the software program for used vehicle parts 100 are important design parametersfor user convenience, the software program for used vehicle parts 100 may be of any size, shape and/or configuration that ensures optimal performance during use and/or that suits the user's needsand/or preferences.

Various modifications and additions can be made to the exemplary embodiments discussed without departing from the scope of the present invention. While the embodiments described above refer to particular features, the scope of this invention also includes embodimentshaving different combinations of features and embodiments that do not include all of the describedfeatures. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologiesfor purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or theclaims, such term is intended to be inclusive in a manner similar to the term “comprising” as “comprising” is interpreted when employed as a transitional word in a claim.

What is claimed is:

1. A method for conducting a vehicle parts exchange program, consisting of an identification software component, a pricing software component, and a payment/shipping software component,
where the identification software component consists of a vehicle part information assessment, where the vehicle part information assessment comprises at least one of the following: a VIN number assessment; an RPO code assessment; an alpha-numeric marking assessment; a license plate number capture; a part number assessment; a bulb type assessment; a tire size assessment; an artificial intelligence component, where the artificial intelligence component allows a user to upload one or more user pictures to the program, where the one or more user pictures are then scanned by the artificial intelligence component to determine a scanned part number; a software picture displaying component, where the user can select from the one or more pictures that matches the user's part or the user's vehicle; a CRM component, where the CRM component allows the user to access a past user history across a variety of automotive websites; or a digital vehicle garage, where the digital vehicle garage displays a user's purchase history in an interactive digital manner,
where the pricing software component consists of a program of obtaining and selling vehicle parts, a user-input selection of a new part to purchase, a computer-generated definition of an old part being replaced, a system calculation of a current pricing of the old part,
the creation of a trade-in offer, where the creation of the trade-in offer considers a number of trade-in components, including at least one of the following: a shipping cost of the part component, a seasonal variations assessment in used part market pricing, a current best market pricing assessment, a third-party (e.g. buyer) volume demands/valuations assessment for parts, an item condition assessment based on a condition of the item (e.g. new, like-new, gentlyused, used, etc.), and a vehicle year/make/model/trim assessment,
the presentation of the trade-in offer to the user, an option for the user to accept the trade-in offer, and a confirmation component in which the user agrees to purchase the new part and agrees to the trade-in offer,
where the payment/shipping software component consists of a program to facilitate the sale of used automobile parts gathered from the sales software component, where the program to facilitate the sale of used automobile parts comprises an advertising of parts component to a refurbisher,
the sending of a quoted price to the refurbisher,
an option for a trade-in option being added to a cart,
a shipping label being sent to the user,
a shipping component where the user ships one or more used parts to the refurbisher,
a receipt component where the refurbisher confirms receipt of the one or more used parts,
and a final bill that is paid by the owner of the method to the customer.

2. The method of claim 1, where the one or more used automobile parts is selected from the group consisting of head lights and taillights.

3. A method for conducting a vehicle parts exchange program, comprising an identification software component, a pricing software component, and a payment/shipping software component,
where the identification software component comprises at least one of the following: a vehicle part information assessment, where the vehicle part information assessment comprises a VIN number assessment, an RPO code assessment, an alpha-numeric marking assessment, a license plate number capture, a part number assessment, a bulb type assessment and a tire size assessment

4. The method of claim 3, where the where the identification software component additionally comprises at least one of the following events: a)an artificial intelligence component, where the artificial intelligence component allows a user to upload one or more user pictures to the program, where the one or more user pictures are then scanned by the artificial intelligence component to determine a scanned part number, b) where the identification software component comprises one or more pictures of a vehicle component, where the user can select from the one or more pictures a matching picture that matches the user's part or the user's vehicle, c) where the identification software component comprises a CRM component, where the CRM component allows the user to access a past user history across a variety of automotive websites, and, d) where the identification software component comprises a digital vehicle garage, where the digital vehicle garage displays a user's purchase history in an interactive digital manner.

5. The method of claim 4, where the pricing software component comprises a program of obtaining and selling vehicle parts, a user-input selection of a new part to purchase, a computer-generated definition of an old part being replaced, a system calculation of a current pricing of the old part,
the creation of a trade-in offer, where the creation of the trade-in offer considers a number of trade-in components, including at least one of the following: a shipping cost of the part component, a seasonal variations assessment in used part market pricing, a current best market pricing assessment, a third-party (e.g. buyer) volume demands/valuations assessment for parts, an item condition assessment based on a condition of the item (e.g. new, like-new, gentlyused, used, etc.), and a vehicle year/make/model/trim assessment,

6. The method of claim 5, where the pricing software component additionally comprises the presentation of the trade-in offer to the user, an option for the user to accept the trade-in offer, and a confirmation component in which the user agrees to purchase the new part and agrees to the trade-in offer,

7. The method of claim 6, where the payment/shipping software component comprises a program to facilitate the sale of used automobile parts gathered from the sales software component, where the program to facilitate the sale of used automobile parts comprises an advertising of parts component to a refurbisher, the sending of a quoted price to the refurbisher, where the payment/shipping software component additionally comprises an option for a trade-in option being added to a cart, a shipping label being sent to the user, a shipping component where the user ships one or more used parts to the refurbisher, a receipt component where the refurbisher confirms receipt of the one or more used parts, and a final bill that is paid by the owner of the method to the customer.

8. The method of claim 7, where the one or more used automobile parts is selected from the group consisting of head lights and taillights.

9. A vehicle parts exchange program, comprising an identification software component, a pricing software component, and a payment/shipping software component,
where the identification software component comprises a criteria assessment, where the criteria assessment comprises a shipping cost of a part, a current best market pricing, a third-party volume demands, a valuations for parts assessment, an item condition assessment, and a vehicle year/make/model/trim assessment related to a vehicle from which the part comes, where the payment/shipping software component comprises a program to facilitate the sale of used automobile parts gathered from the sales software component, where the program to facilitate the sale of used automobile parts comprises an advertising of parts component to a refurbisher, the sending of a quoted price to the refurbisher,

10. The program of claim 9, where the identification software component comprises a vehicle part information assessment, where the vehicle part information assessment comprises at least one of the following: a VIN number assessment, an RPO code assessment, an alpha-numeric marking assessment, a license plate number capture, a part number assessment, a bulb type assessment and a tire size assessment, where the pricing software component comprises a program of obtaining and selling vehicle parts, a user-input selection of a new part to purchase, a computer-generated definition of an old part being replaced, a system calculation of a current pricing of the old part,

11. The program of claim 10, where the identification software component additionally comprises at least one of the following: an artificial intelligence component that allows a user to upload one or more user pictures to the program, where the one or more user pictures are then scanned by the artificial intelligence component to determine a scanned part number; a component that comprises one or more pictures of a vehicle component, where the user can select from the one or more pictures a matching picture that matches the user's part or the user's vehicle; a CRM component, where the CRM component allows the user to access a past user history across a variety of automotive websites; and, a digital vehicle garage, where the digital vehicle garage displays a user's purchase history in an interactive digital manner.

12. The program of claim 11, where the pricing software component additionally comprises the creation of a trade-in offer, where the creation of the trade-in offer considers a number of trade-in components, including at least one of the following: a shipping
cost of the part component, a seasonal variations assessment in used part market pricing, a current best market pricing assessment, a third-party (e.g., buyer) volume demands/valuations assessment for parts, an item condition assessment based on a condition of the item (e.g., new, like-new, gentlyused, used, etc.), and a vehicle year/make/model/trim assessment,

13. The method of claim 12, where the pricing software component additionally comprises the presentation of the trade-in offer to the user, an option for the user to accept the trade-in offer, and a confirmation component in which the user agrees to purchase the new part and agrees to the trade-in offer,

14. The program of claim 13, where the payment/shipping software component additionally comprises an option for a trade-in option being added to a cart, a shipping label being sent to the user, a shipping component where the user ships one or more used parts to the refurbisher, a receipt component where the refurbisher confirms receipt of the one or more used parts, and a final bill that is paid by the refurbisher to the owner of the method, where the one or more used automobile parts is selected from the group consisting of head lights and tail lights.

15. A software system for conducting a vehicle parts exchange program, comprising: A method for conducting a vehicle parts exchange program, comprising an identification software component, a pricing software component, and a payment/shipping software component.

16. The software system of claim 15,
where the identification software component comprises a vehicle part information assessment, where the vehicle part information assessment comprises at least one of the following: a VIN number assessment; an RPO code assessment; an alpha-numeric marking assessment; a license plate number capture; a part number assessment; a bulb type assessment; a tire size assessment; an artificial intelligence component, where the artificial intelligence component allows a user to upload one or more user pictures to the program, where the one or more user pictures are then scanned by the artificial intelligence component to determine a scanned part number; a software picture displaying component, where the user can select from the one or more pictures that matches the user's part or the user's vehicle; a CRM component, where the CRM component allows the user to access a past user history across a variety of automotive websites; and, where the identification software component comprises a digital vehicle garage, where the digital vehicle garage displays a user's purchase history in an interactive digital manner.

17. The software system of claim 15, where the pricing software component comprises a program of obtaining and selling vehicle parts, a user-input selection of a new part to purchase, a computer-generated definition of an old part being replaced, a system calculation of a current pricing of the old part,
the creation of a trade-in offer, where the creation of the trade-in offer considers a number of trade-in components, including at least one of the following: a shipping cost of the part component, a seasonal variations assessment in used part market pricing, a current best market pricing assessment, a third-party (e.g. buyer) volume demands/valuations assessment for parts, an item condition assessment based on a condition of the item (e.g. new, like-new, gentlyused, used, etc.), and a vehicle year/make/model/trim assessment, where the pricing software component additionally comprises the presentation of the trade-in offer to the user, an option for the user to accept the trade-in offer, and a confirmation component in which the user agrees to purchase the new part and agrees to the trade-in offer,

18. The software system of claim 15, where the payment/shipping software component comprises a program to facilitate the sale of used automobile parts gathered from the sales software component, where the program to facilitate the sale of used automobile parts comprises an advertising of parts component to a refurbisher, the sending of a quoted price to the refurbisher, where the payment/shipping software component additionally comprises an option for a trade-in option being added to a cart, a shipping label being sent to the user, a shipping component where the user ships one or more used parts to the refurbisher, a receipt component where the refurbisher confirms receipt of the one or more used parts, and a final bill that is paid by the owner of the method to the customer.

19. The software system of claim 15 where the identification software component comprises a criteria assessment, where the criteria assessment comprises a shipping cost of a part, a measure of seasonal variations in used part market pricing, a current best market pricing, a third-party volume demands, a valuations for parts assessment, an item condition assessment, and a vehicle year/make/model/trim assessment related to a vehicle from which the part comes,
where the identification software component comprises a vehicle part information assessment, where the vehicle part information assessment comprises a VIN number assessment, an RPO code assessment, an alpha-numeric marking assessment, a license plate number capture, a part number assessment, a bulb type assessment and a tire size assessment, where the where the identification software component additionally comprises an artificial intelligence component, where the artificial intelligence component allows a user to upload one or more user pictures to the program, where the one or more user pictures are then scanned by the artificial intelligence component to determine a scanned part number, where the identification software component comprises one or more pictures of a vehicle component, where the user can select from the one or more pictures a matching picture that matches the user's part or the user's vehicle, where the identification software component comprises a CRM component, where the CRM component allows the user to access a past user history across a variety of automotive websites, and, where the identification software component comprises a digital vehicle garage, where the digital vehicle garage displays a user's purchase history in an interactive digital manner, where the pricing software component comprises a program of obtaining and selling vehicle parts, a user-input selection of a new part to purchase, a computer-generated definition of an old part being replaced, a system calculation of a current pricing of the new part,
the creation of a trade-in offer, where the creation of the trade-in offer considers a number of trade-in components, including a shipping cost of the part component, a seasonal variations assessment in used part market pricing, a current best market pricing assessment, a third-party (e.g. buyer) volume demands/valuations assessment for parts, an item condition assessment based on a condition of the item (e.g. new, like-new, gently used, used, etc.), and a vehicle year/make/model/trim assessment, where the pricing software component additionally comprises the presentation of the trade-in offer to the user, an option for the user to accept the trade-in offer, and a confirmation component in which the user agrees to purchase the new part and agrees to the trade-in offer, where the payment/shipping software component comprises a program to facilitate the sale of used automobile parts gathered from the sales software component, where the program to facilitate the sale of used automobile parts comprises an advertising of parts component to a refurbisher, the sending of a quoted price to the refurbisher, where the payment/shipping software component additionally comprises an option for a trade-in option being added to a cart, a shipping label being sent to the user, a shipping component where the user ships one or more used parts to the refurbisher, a receipt component where the refurbisher confirms receipt of the one or more used parts, and a final bill that is paid by the user to the owner of the method.

20. The software system of claim 19, where the one or more used automobile parts is selected from the group consisting of head lights and taillights.
